(19) United States
(12) Patent Application Publication
(10) Pub. No.: US 2023/0410787 A1
(43) Pub. Date: Dec. 21, 2023

(54) SPEECH PROCESSING SYSTEM WITH ENCODER-DECODER MODEL AND CORRESPONDING METHODS FOR SYNTHESIZING SPEECH CONTAINING DESIRED SPEAKER IDENTITY AND EMOTIONAL STYLE

(71) Applicant: Innocorn Technology Limited, Hong Kong (CN)

(72) Inventor: Kwok Leung LEE, Hong Kong (HK)

(21) Appl. No.: 18/314,408

(22) Filed: May 9, 2023

(30) Foreign Application Priority Data
May 18, 2022 (HK) 32022053676.9

(51) Int. Cl. G10L 13/027; G10L 25/30; G10L 17/26

(52) U.S. Cl. CPC G10L 13/027; G10L 17/26; G10L 25/30

(57) ABSTRACT

Embodiments of the present application provide a speech processing system, a speech processing method, and a terminal device. The speech processing system is mounted on a terminal device, the speech processing system includes at least one speech engine module, the at least one speech engine module is provided therein with a trained deep learning model, and the trained deep learning model includes an encoder and a decoder, where the encoder is configured to obtain a speaker identity when a to-be-processed speech service is played; and the decoder is configured to process the speaker identity, text information corresponding to the to-be-processed speech service, and an emotional style expected to be output by the to-be-processed speech service to obtain a processing result of the to-be-processed speech service. The present application can enrich a speech output effect output by using a text to speech (TTS) engine.

### TECHNICAL FIELD

The present application relates to the field of communication technologies, and in particular, to a speech processing system, a speech processing method, and a terminal device.

### BACKGROUND

With the development of the smart speech recognition technology, the smart speech recognition technology has great advantages in resolving speech problems and can greatly improve experience of human-computer interaction. Currently, there are many speech recognition products based on an embedded terminal.

In the research, the inventor found that the speech output achieved by using a text to speech (TTS) engine is mediocre. For example, news reporting is monotonous and film dubbing is stilted. In this way, the speech output achieved by using a text to speech (TTS) engine cannot meet personalized needs. Therefore, how to enrich the speech output by using the TTS engine to meet the personalized needs is a problem to be urgently resolved.

### SUMMARY

Embodiments of the present application provide a speech processing system, a speech processing method, and a terminal device, such that a synthesized speech containing a speaker identity and an emotional style can be obtained by using a speech engine module, thereby enriching a speech output effect.

According to a first aspect, an embodiment of the present application provides a speech processing system. The speech processing system includes at least one speech engine module. The at least one speech engine module is provided therein with a trained deep learning model, and the trained deep learning model includes an encoder and a decoder. The encoder is configured to obtain a speaker identity when a to-be-processed speech service is played. The decoder is configured to process the speaker identity, text information corresponding to the to-be-processed speech service, and an emotional style expected to be output by the to-be-processed speech service to obtain a processing result of the to-be-processed speech service.

According to this embodiment of the present application, the processing result of the to-be-processed speech service is obtained by using the deep learning model in the speech engine module (for example, the processing result may include but is not limited to a synthesized speech). The processing result of the to-be-processed speech service contains the speaker identity and the emotional style. In this way, a speech output effect achievable by using a TTS engine is enriched, and personalized needs of different users can be met.

It should be noted that the speech engine module mentioned in the present application may include at least one of a Chinese TTS engine and an English TTS engine.

In an implementation, the encoder includes an N-layer structure, and each layer includes a first multi-head self-attention layer and a first feedforward neural network; and the decoder includes an N-layer structure, and each layer includes a second multi-head self-attention layer, a second feedforward neural network, and a multi-head attention layer; where the multi-head attention layer is configured to execute a multi-head attention mechanism for the speaker identity output by the encoder, and N is an integer greater than 0.

In an implementation, the speech processing system further includes a configuration module and a speech control module that are connected to the at least one speech engine module. The configuration module is configured to receive a playback parameter set by a user for the processing result of the to-be-processed speech service; and the speech control module is configured to play the processing result of the to-be-processed speech service based on the playback parameter

According to this embodiment of the present application, after the processing result of the to-be-processed speech service is obtained by using the deep learning model in the speech engine module (for example, the processing result may include but is not limited to a synthesized speech), the playback parameter for the processing result of the to-be-processed speech service can be set. The playback parameter may include but is not limited to a playback speed and a playback volume, such that the processing result of the to-be-processed speech service can be played based on the set playback parameter. In this way, a speech output effect achievable by using a TTS engine is enriched, and personalized needs of different users can be met.

In an implementation, the speaker identity when the to-be-processed speech service is played includes one hundred people of different ages from all walks of life.

In an implementation, the emotional style expected to be output by the to-be-processed speech service includes one of happiness, sadness, disgust, fear, surprise, and anger.

According to a second aspect, an embodiment of the present application provides a speech processing method. The speech processing method is applied to a speech processing system, the speech processing system includes at least one speech engine module, the at least one speech engine module is provided therein with a trained deep learning model, and the trained deep learning model includes an encoder and a decoder. The speech processing method includes: obtaining a to-be-processed speech service; obtaining, by using the encoder, a speaker identity when the to-be-processed speech service is played; and processing, by using the decoder, the speaker identity, text information corresponding to the to-be-processed speech service, and an emotional style expected to be output by the to-be-processed speech service to obtain a processing result of the to-be-processed speech service.

In an implementation, the encoder has an N-layer structure, and each layer includes a first multi-head self-attention layer and a first feedforward neural network; and the decoder has an N-layer structure, and each layer includes a second multi-head self-attention layer, a second feedforward neural network, and a multi-head attention layer; where the multi-head attention layer is configured to execute a multi-head attention mechanism for the speaker identity output by the encoder, and N is an integer greater than 0.

In an implementation, the speech processing system further includes a configuration module and a speech control module that are connected to the at least one speech engine module, and the speech processing method further includes: receiving, by using the configuration module, a playback parameter set by a user for the processing result of the to-be-processed speech service; and playing, by using the speech control module, the processing result of the to-be-processed speech service based on the playback parameter.

In an implementation, the speaker identity when the to-be-processed speech service is played includes one hundred people of different ages from all walks of life.

In an implementation, the emotional style expected to be output by the to-be-processed speech service includes one of happiness, sadness, disgust, fear, surprise, and anger.

According to a third aspect, an embodiment of the present application provides a terminal device, including a processor and a memory, where the processor and the memory are connected to each other, the memory is configured to store a computer program that includes a program instruction, and the processor is configured to invoke the program instruction to execute any speech processing method described in the second aspect.

According to a fourth aspect, an embodiment of the present application provides a computer-readable storage medium, where the computer-readable storage medium stores a computer program that includes a program instruction, and the program instruction is executed by a processor to execute any speech processing method described in the second aspect.

According to a fifth aspect, an embodiment of the present application provides a computer program, where the computer program includes a program instruction, and the program instruction is executed by a processor to execute any speech processing method described in the second aspect.

In summary, the processing result of the to-be-processed speech service is obtained by using the deep learning model in the speech engine module (for example, the processing result may include but is not limited to a synthesized speech). The processing result of the to-be-processed speech service contains the speaker identity and emotional style. In this way, a speech output effect achievable by using a TTS engine is enriched, and personalized needs of different users can be met. In addition, the playback parameter for the processing result of the to-be-processed speech service can be set. The playback parameter may include but is not limited to a playback speed and a playback volume, such that the processing result of the to-be-processed speech service can be played based on the set playback parameter. In this way, personalized needs of a user in different scenarios can be met on a basis of enriching the speech output effect.

### BRIEF DESCRIPTION OF THE DRAWINGS

To explain the technical solutions in embodiments of the present application more clearly, the accompanying drawings required in the embodiments will be described below in brief

FIG. 1a is a schematic flowchart of a deep learning model according to an embodiment of the present application;

FIG. 1b is a schematic structural diagram of a deep learning model according to an embodiment of the present application;

FIG. 1c shows a Transformer-XL model according to an embodiment of the present application;

FIG. 2a is a schematic diagram showing an architecture of a speech processing system according to an embodiment of the present application;

FIG. 2b is a schematic diagram showing an architecture of another speech processing system according to an embodiment of the present application;

FIG. 2c is a schematic flowchart of a speech processing method according to an embodiment of the present application.

### DETAILED DESCRIPTION OF THE EMBODIMENTS

The following describes the technical solutions in the embodiments of the present application with reference to the accompanying drawings in the embodiments of the present application.

The terms “first”, “second”, and so on in the specification and accompanying drawings of the present application are intended to distinguish different objects or different processing of a same object, but do not necessarily indicate a specific order or sequence of the objects. In addition, the terms “include”, “have” and any variations thereof in the description of the present application are intended to cover non-exclusive inclusions. For example, a process, method, system, product or device that includes a series of steps or units is not limited to the listed steps or units. Optionally, it also includes steps or units that are not listed, or optionally also includes other steps or units inherent to the process, method, product or device. It should be noted that the word “exemplary”, “for example”, or the like in the embodiments of the present application represents serving as an example, instance or illustration. Any embodiment or design method described herein as “exemplary” or “for example” in the embodiments of the present application should not be construed as being more preferred or advantageous over other embodiments or design solutions. Exactly, the word “exemplary”, “for example”, or the like is intended to present related concepts specifically. In the embodiments of the present application, “A and/or B” means A and B, and A or B alone. “A, and/or B, and/or C” means any one of A, B and C, or any two of A, B and C, or A, B and C.

The following describes, from the aspects of model training and model application, a method provided in the present application.

A training method for a deep learning model provided in the embodiments of the present application relates to processing of computer vision or natural language, which can be specifically applied to speech processing methods such as data training, machine learning, and deep learning, and carry out symbolic and formal smart information modeling, extraction, preprocessing and training on training data, so as to finally obtain a trained deep learning model. Moreover, a speech processing method provided in the embodiments of the present application can use the above trained deep learning model to input data (such as an audio file in the present application) to the trained deep learning model to obtain output data (such as a processing result of a to-be-processed speech service). It should be noted that the training method for a deep learning model and the speech processing method provided in the embodiments of the present application are based on a same idea, and can also be understood as two parts of a system, or two stages of an overall process, namely, a model training stage and a model application stage.

First, the method provided in the present application is described from the aspect of model training.

An embodiment of the present application provides a training method for a deep learning model. The training method for a deep learning model is applied to training of a specific task/prediction model.

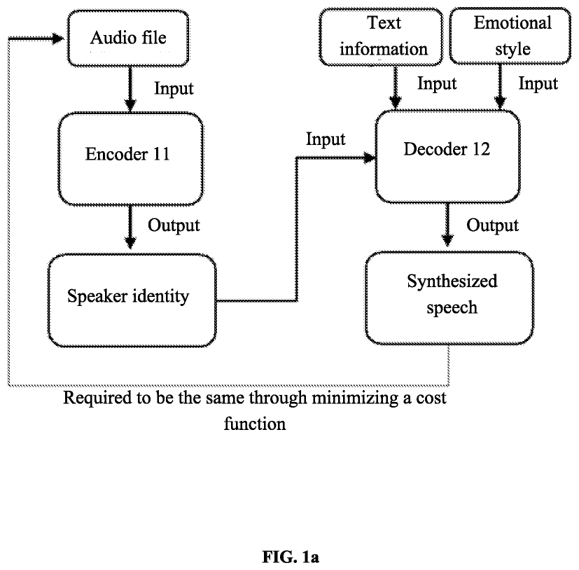

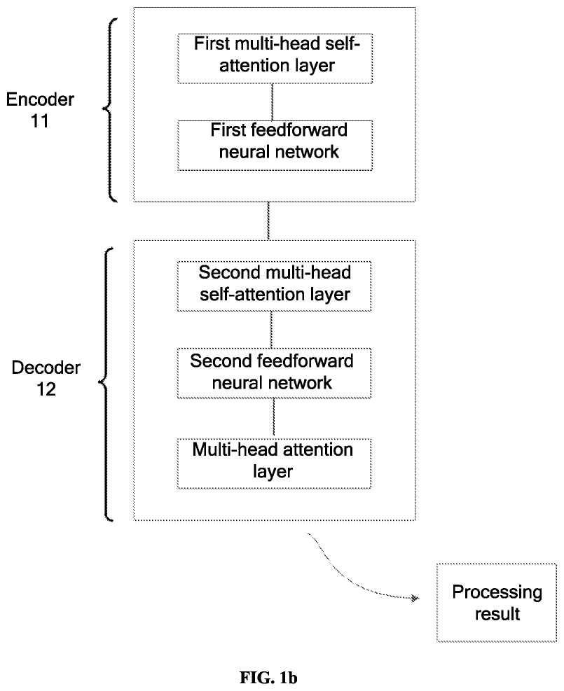

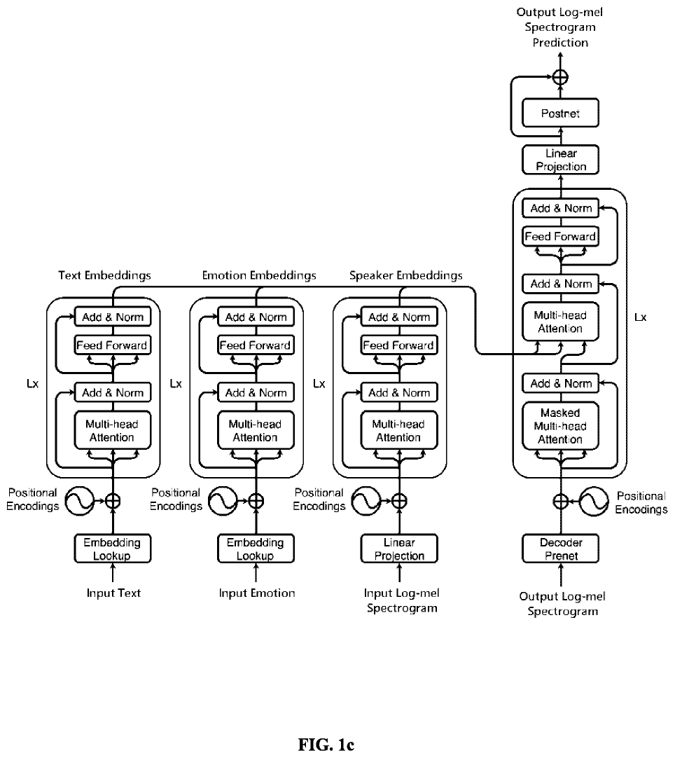

As shown in FIG. 1a, the deep learning model includes an encoder 11 and a decoder 12. A to-be-processed speech service (for example, an audio file) is input to the encoder 11 to obtain a speaker identity when the to-be-processed speech service is played. After that, the speaker identity when the to-be-processed speech service is played, text information corresponding to the to-be-processed speech service, and an emotional style expected to be output by the to-be-processed speech service are input to the decoder 12 to output a processing result of the to-be-processed speech service. For example, the processing result may be a synthesized speech.

In some embodiments, the encoder 11 may have an N-layer structure, and each layer includes a first multi-head self-attention layer and a first feedforward neural network; and the decoder 12 may have an N-layer structure, and each layer includes a second multi-head self-attention layer, a second feedforward neural network, and a multi-head attention layer. Herein, N is an integer greater than 0.

In some embodiments, the first multi-head self-attention layer of the encoder 11 and the second multi-head self-attention layer of the decoder 12 may be a same mechanism module.

In some embodiments, the first feedforward neural network of the encoder 11 and the second feedforward neural network of the decoder 12 may be a same mechanism module.

In some embodiments, between the layers in each of the encoder 11 and the decoder 12, residual connection and layer normalization need to be performed before an input to a next layer and after an output from a previous layer.

In practical application, for the encoder 11, the to-be-processed speech service is input to the first multi-head self-attention layer; and after performing processing, the first multi-head self-attention layer outputs processed data to the first feedforward neural network for processing, and outputs the speaker identity when the to-be-processed speech service is played. For the decoder 12, the speaker identity when the to-be-processed speech service is played, the text information corresponding to the to-be-processed speech service, and the emotional style expected to be output by the to-be-processed speech service are input to the second multi-head self-attention layer; and after performing processing, the second multi-head self-attention layer outputs processed data to the second feedforward neural network for processing. At the same time, the multi-head attention layer executes a multi-head attention mechanism for the speaker identity when the to-be-processed speech service is played, so as to output the processing result of the to-be-processed speech service. For example, the processing result may be the synthesized speech.

In this embodiment of the present application, after the structures of the encoder and the decoder of the deep learning model are determined, a cost function is constructed, and a sample dataset is used to jointly train the encoder and the decoder of the deep learning model offline. When the cost function is minimized, the training is stopped, and respective feedback model parameters of the encoder and the decoder are obtained. After that, the feedback model parameters are input into the encoder and decoder respectively, so as to obtain a trained deep learning model. Herein, the sample dataset may include a plurality of types of audio files, for example, an audio file obtained when user A reads article B happily, and an audio file obtained when user A reads article B sadly.

In some embodiments, to ensure that original speeches can be restored after the decoding process, both the encoder 11 and decoder 12 are trained simultaneously. An approach of training is similar to that of training a Transformer-XL model which has a sequence-to-sequence encoder-decoder architecture. During the training, the encoder-decoder model will be optimized via backpropagation using an L1 or L2 loss. For example, an objective cost function which minimizes a sum of square differences between the synthesized speech output from the decoder and a speech input to the encoder is set to gradually optimize the whole encoder-decoder model, so as to obtain a trained Transformer-XL model.

It should be noted that the transformer-XL model mentioned above is only an example and should not constitute a limitation.

Next, the method provided in the present application is described from the aspect of model application.

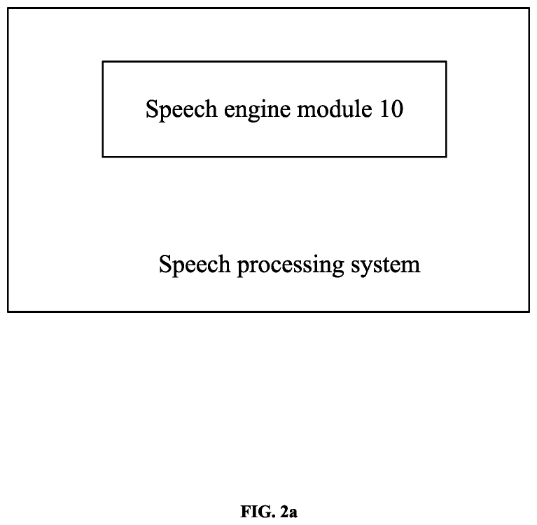

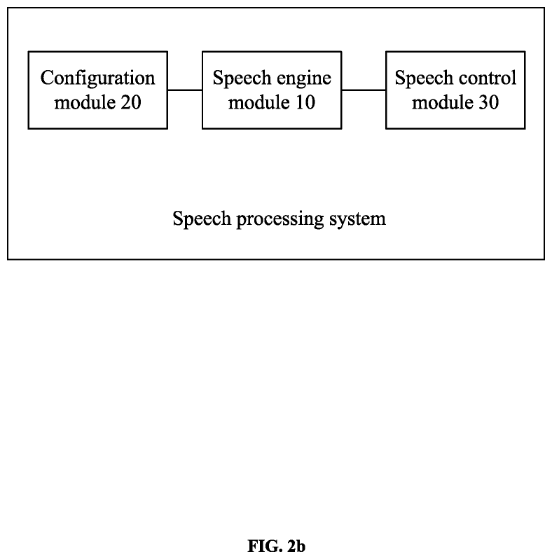

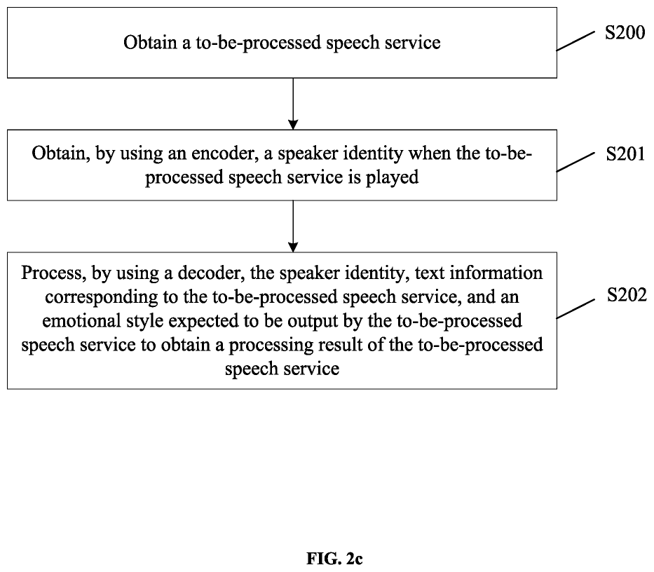

An embodiment of the present application provides a speech processing system. As shown in FIG. 2a, the speech processing system includes at least one speech engine module 10, the speech engine module 10 is provided therein with a trained deep learning model, and the trained deep learning model includes an encoder and a decoder.

The encoder is configured to obtain a speaker identity when a to-be-processed speech service is played.

The decoder is configured to process the speaker identity, text information corresponding to the to-be-processed speech service, and an emotional style expected to be output by the to-be-processed speech service to obtain a processing result of the to-be-processed speech service.

In this embodiment of the present application, the speech engine module may include but is not limited to a Chinese TTS engine, an English TTS engine, and the like.

In actual application, speech engine modules matching different demand scenarios may be configured. For example, language types of speech may be configured for the speech processing system based on needs of different regions, so as to realize local speech applications.

It should be noted that the speech processing system provided in the present application allows creating, through an interactive panel, a specific speaker identity which may not exist in the world. The input audio file (for example, characteristics of voice) is changed to generate a desired speaker identity. This reduces the cost of finding a real person who has desired speaking characteristics, and helps to avoid using some vocals that may violate privacy.

An embodiment of the present application provides another speech processing system. As shown in FIG. 2b, the speech processing system includes at least one speech engine module 10, a configuration module 20, and a speech control module 30.

The configuration module 20 is configured to receive a playback parameter set by a user for a processing result of a to-be-processed speech service.

The speech control module 30 is configured to play the processing result of the to-be-processed speech service based on the playback parameter.

Herein, the playback parameter may include but is not limited to a playback speed and a playback volume.

It should be noted that a configuration action performed by the configuration module 20 may be set after or before the processing result of the to-be-processed speech service is obtained. This is not specifically limited in the present application.

The speech processing system shown in FIG. 2a is used as an example. As shown in FIG. 2c, the present application further provides a speech processing method. The speech processing method may include the following steps.

Step S200: Obtain a to-be-processed speech service.

In this embodiment of the present application, the to-be-processed speech service is a to-be-processed audio file, for example, an audio file with a speaker identity and generated by a user based on an interactive interface and a recording resource.

It should be noted that one audio file can be recorded at a same moment.

Step S201: Obtain, by using the encoder, a speaker identity when the to-be-processed speech service is played.

In this embodiment of the present application, the speaker identity when the to-be-processed speech service is played includes one hundred people of different ages from all walks of life.

Step S202: Process, by using the decoder, the speaker identity, text information corresponding to the to-be-processed speech service, and an emotional style expected to be output by the to-be-processed speech service to obtain a processing result of the to-be-processed speech service.

In this embodiment of the present application, the emotional style expected to be output by the to-be-processed speech service includes one of happiness, sadness, disgust, fear, surprise, and anger.

It should be noted that the emotional style expected to be output by the to-be-processed speech service can be deleted based on a user need, which is not limited herein.

In summary, the processing result of the to-be-processed speech service is obtained by using the deep learning model in the speech engine module (for example, the processing result may include but is not limited to a synthesized speech). The processing result of the to-be-processed speech service contains the speaker identity and emotional style. In this way, a speech output effect achievable by using a TTS engine is enriched, and personalized needs of different users can be met. In addition, the playback parameter for the processing result of the to-be-processed speech service can be set. The playback parameter may include but is not limited to a playback speed and a playback volume, such that the processing result of the to-be-processed speech service can be played based on the set playback parameter. In this way, personalized needs of a user in different scenarios can be met on a basis of enriching the speech output effect.

In order to better understand the present application, the following describes a scenario to which the present application can be applied.

In some embodiments, the method provided in the present application can be applied to news reporting. A synthesized speech can be obtained by using the speech processing system in the present application, to report news with suitable voice and tone.

In some embodiments, the method provided in the present application can be applied to movie dubbing. A synthesized speech can be obtained by using the speech processing system in the present application, to develop characters with suitable voice and tone.

In some embodiments, the method provided in the present application can be applied to retail or shopping malls. A synthesized speech can be obtained by using the speech processing system in the present application, to answer questions of customers and provide relevant information to the customers with suitable voice and tone, so as to improve sales. This enriches shopping experience of the customers.

The above merely describes specific implementations of the present application, but the protection scope of the present application is not limited thereto. Any person skilled in the art can easily conceive modifications or replacements within the technical scope of the present application, and these modifications or replacements shall fall within the protection scope of the present application. Therefore, the protection scope of the present application should be subject to the protection scope of the claims.

What is claimed is:

1. A speech processing system, wherein the speech processing system is mounted on a terminal device, the speech processing system comprises at least one speech engine module, the at least one speech engine module is provided therein with a trained deep learning model, and the trained deep learning model comprises an encoder and a decoder, wherein
the encoder is configured to obtain a speaker identity when a to-be-processed speech service is played; and
the decoder is configured to process the speaker identity, text information corresponding to the to-be-processed speech service, and an emotional style expected to be output by the to-be-processed speech service to obtain a processing result of the to-be-processed speech service.

2. The system according to claim 1, wherein the encoder has an N-layer structure, and each layer comprises a first multi-head self-attention layer and a first feedforward neural network; and the decoder has an N-layer structure, and each layer comprises a second multi-head self-attention layer, a second feedforward neural network, and a multi-head attention layer; wherein the multi-head attention layer is configured to execute a multi-head attention mechanism for the speaker identity output by the encoder, and N is an integer greater than 0.

3. The system according to claim 1, wherein the speech processing system further comprises a configuration module and a speech control module that are connected to the at least one speech engine module, wherein
the configuration module is configured to receive a playback parameter set by a user for the processing result of the to-be-processed speech service; and
the speech control module is configured to play the processing result of the to-be-processed speech service based on the playback parameter.

4. The system according to claim 1, wherein the speaker identity when the to-be-processed speech service is played comprises one hundred people of different ages from all walks of life. And the speaking identity is related to the number of combinations of all the dimensions in the speaker embeddings which describing the voice characteristics of the speaker.

5. The system according to claim 1, wherein the emotional style expected to be output by the to-be-processed speech service comprises one of happiness, sadness, disgust, fear, surprise, and anger. And with a larger dataset with more emotion styles, it can represent more.

6. A speech processing method, wherein the speech processing method is applied to a speech processing system, wherein the speech processing system comprises at least one speech engine module, the at least one speech engine module is provided therein with a trained deep learning model, and the trained deep learning model comprises an encoder and a decoder; and the speech processing method comprises:
obtaining a to-be-processed speech service;
obtaining, by using the encoder, a speaker identity when the to-be-processed speech service is played; and
processing, by using the decoder, the speaker identity, text information corresponding to the to-be-processed speech service, and an emotional style expected to be output by the to-be-processed speech service to obtain a processing result of the to-be-processed speech service.

7. The method according to claim 6, wherein the encoder has an N-layer structure, and each layer comprises a first multi-head self-attention layer and a first feedforward neural network; and the decoder has an N-layer structure, and each layer comprises a second multi-head self-attention layer, a second feedforward neural network, and a multi-head attention layer; wherein the multi-head attention layer is configured to execute a multi-head attention mechanism for the speaker identity output by the encoder, and N is an integer greater than 0.

8. The method according to claim 6, wherein the speech processing system further comprises a configuration module and a speech control module that are connected to the at least one speech engine module, and the method further comprises:
receiving, by using the configuration module, a playback parameter set by a user for the processing result of the to-be-processed speech service; and
playing, by using the speech control module, the processing result of the to-be-processed speech service based on the playback parameter.

9. The method according to claim 6, wherein the speaker identity when the to-be-processed speech service is played comprises one hundred people of different ages from all walks of life. And the speaking identity is related to the number of combinations of all the dimensions in the speaker embeddings which describing the voice characteristics of the speaker.

10. The method according to claim 6, wherein the emotional style expected to be output by the to-be-processed speech service comprises one of happiness, sadness, disgust, fear, surprise, and anger. And with a larger dataset with more emotion styles, it can represent more.
